(19) United States
(12) Patent Application Publication
(10) Pub. No.: US 2009/0076700 A1
(43) Pub. Date: Mar. 19, 2009

(54) APPARATUS AND METHOD FOR MANAGING VEHICLE SPEED

(75) Inventor: ASSAD RADPOUR, AUSTIN, TX (US)

Correspondence Address: AKERMAN SENTERFITT, P.O. BOX 3188, WEST PALM BEACH, FL, 33402-3188, US

(73) Assignee: AT&T KNOWLEDGE VENTURES, L.P., RENO, NV (US)

(21) Appl. No.: 11/855,703

(22) Filed: Sep. 14, 2007

(51) Int. Cl. G06F 17/00; B60Q 1/00

(52) U.S. Cl. 701/93; 340/438

(57) ABSTRACT

A system that incorporates teachings of the present disclosure may include, for example, a communication device having a controller to receive speed limit information from a remote wireless transmitter where the speed limit information comprising a speed limit and an applicable speed area, receive location information associated with a vehicle, determine a location of the vehicle based at least in part on the location information, determine a speed of the vehicle, determine an excessive speed when the speed of the vehicle exceeds the speed limit and when the location of the vehicle is within the applicable speed area, and provide a driver notification of the excessive speed according to a user profile associated with a driver of the vehicle. Other embodiments are disclosed.

### FIELD OF THE DISCLOSURE

The present disclosure relates generally to communication systems and more specifically to an apparatus and method for managing vehicle speed.

### BACKGROUND

Posted speed limits, especially in busy areas such as school or construction zones, often go undetected by drivers. This can be exacerbated by obstructions to speed limit signs, such as overgrown trees or parked vehicles along the side of the road, as well as by mistaken or intentional removal of speed limit signs, such as resulting from an accident with the sign or vandalism. In such occurrences, the lack of signage indicating the speed limit can go undetected for some period of time before corrective action is taken.

### BRIEF DESCRIPTION OF THE DRAWINGS

FIG. 1 depicts an exemplary embodiment of a communication system;

FIGS. 2-3 depict exemplary block diagrams of two of several embodiments for communication devices operating in the communication system;

FIGS. 4-5 depict exemplary methods operating in portions of the communication system; and

FIG. 6 is a diagrammatic representation of a machine in the form of a computer system within which a set of instructions, when executed, may cause the machine to perform any one or more of the methodologies discussed herein.

### DETAILED DESCRIPTION

In one embodiment of the present disclosure, a computer-readable storage medium can have computer instructions for receiving speed limit information from a remote wireless transmitter where the speed limit information includes a speed limit and an applicable speed area, receiving location information associated with a vehicle, determining a location of the vehicle based at least in part on the location information, determining a speed of the vehicle, determining an excessive speed when the speed of the vehicle exceeds the speed limit and when the location of the vehicle is within the applicable speed area, providing a driver notification of the excessive speed, and adjusting the speed of the vehicle when corrective action has not been taken by a driver within a pre-determined time period.

In one embodiment of the present disclosure, a communication device can have a controller to receive speed limit information from a remote wireless transmitter where the speed limit information comprising a speed limit and an applicable speed area, receive location information associated with a vehicle, determine a location of the vehicle based at least in part on the location information, determine a speed of the vehicle, determine an excessive speed when the speed of the vehicle exceeds the speed limit and when the location of the vehicle is within the applicable speed area, and provide a driver notification of the excessive speed according to a user profile associated with a driver of the vehicle.

In one embodiment of the present disclosure, a communication device can have a controller to wirelessly broadcast speed limit information and public safety information, where the speed limit information includes a speed limit and an applicable speed area, where a vehicle determines an excessive speed based on the speed limit information and location information received from a global positioning system, and where the vehicle presents a driver notification comprising the excessive speed and at least a portion of the public safety information.

In one embodiment of the present disclosure, a communication device can have a controller to receive speed limit information from a remote wireless transmitter where the speed limit information comprising a speed limit and an applicable speed area, receive location information associated with a vehicle, determine a location of the vehicle based at least in part on the location information, determine a speed of the vehicle, determine an excessive speed when the speed of the vehicle exceeds the speed limit and when the location of the vehicle is within the applicable speed area; and adjust the speed of the vehicle based at least in part on the excessive speed

In one embodiment of the present disclosure, a method can involve transmitting speed limit information from a remote wireless transmitter to a first receiver of a vehicle where the speed limit information comprising a speed limit and an applicable speed area, transmitting location information from a global positioning system to a second receiver of the vehicle, the location information being associated with the vehicle, determining a location of the vehicle based at least in part on the location information, determining a speed of the vehicle, determining an excessive speed when the speed of the vehicle exceeds the speed limit and when the location of the vehicle is within the applicable speed area, storing occurrences of the excessive speed over a time period, and presenting the occurrences of the excessive speed in response to a user's request.

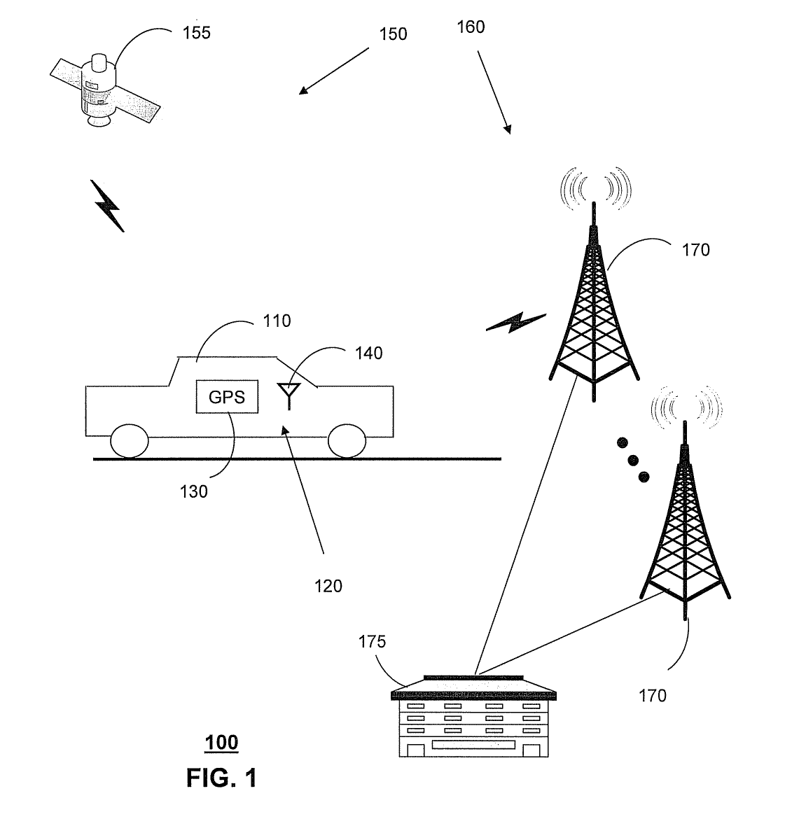

FIG. 1 depicts an exemplary embodiment of a communication system 100 usable with a vehicle 110, such as a motor vehicle. However, the present disclosure contemplates the use of communication system 100 with other vehicles, including boats, trains, and airplanes. Communication system 100 can comprise a location determination system 150 and a speed limit broadcasting system 160. The location determination system 150 can be a global positioning system (GPS) having a GPS receiver 130 positioned in the vehicle 110 and receiving signals from one or more GPS satellites 155. However, the present disclosure also contemplates the use of other components and techniques for monitoring and determining the location of the vehicle 110.

The speed limit broadcasting system 160 can be a terrestrial wireless broadcasting system having one or more transmitters 170 that can transmit signals for receipt by a receiver 140 positioned in the vehicle 110. The broadcasting system 160 can utilize various modes of wireless communication, including GSM, GPRS, EDGE, CDMA-1X, UMTS, WiMAX, software defined radio (SDR), WiFi, and other known and future technologies.

In one embodiment, the speed limit broadcasting system 160 can include a plurality of transmitters 170 that are coupled with a central office 175, such as through wireline communication. The central office 175 can include various components, such as a controller, communications interface and memory, and can utilize various protocols for communication with the transmitters 170, as well as with other communication or network devices, including the Emergency Broadcasting System. The central office 175 can provide each of the transmitters 170 with the appropriate speed limit to be broadcast. In another embodiment, the central office 170 can provide public safety information to be broadcast to the vehicles by the transmitters, such as Amber Alerts, weather conditions, and so forth. However, the present disclosure also contemplates the speed limit broadcasting system 160 comprising one or more autonomous transmitters 170. For example, a transmitter 170 can be a mobile device that is positionable in a construction zone or an accident area where a speed limit reduction has been implemented.

In one embodiment, the GPS receiver 130 and the wireless signal receiver 140 are part of a communication system 120 that can be incorporated into the control or electronic system of the vehicle 110, including sharing one or more components such as memory storage or processing devices. In another embodiment, the communication system 120 can be a modular system that is connectable with the vehicle 110 and configured with other components of the vehicle.

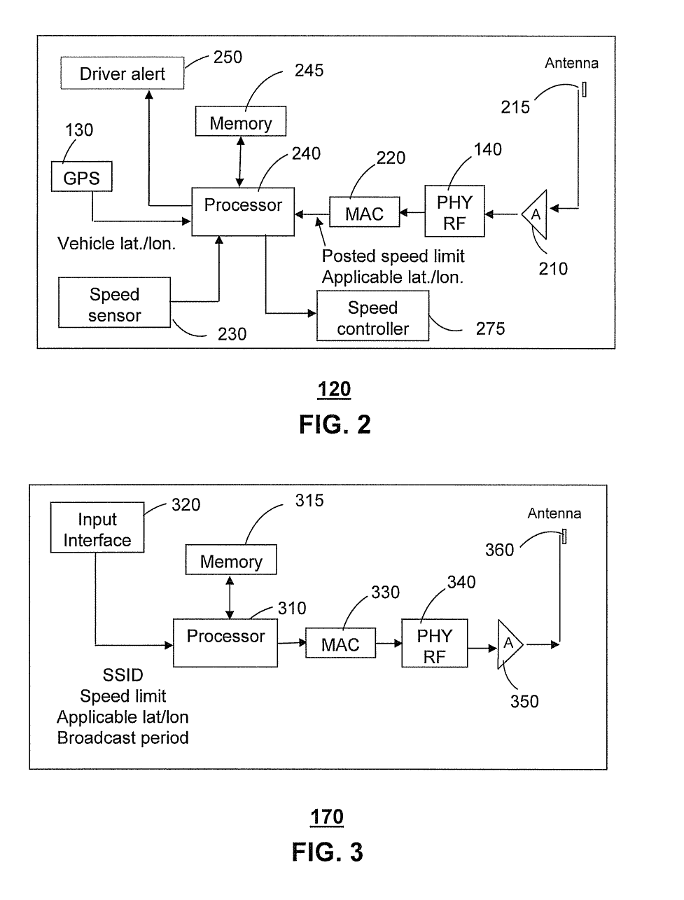

FIG. 2 depicts an exemplary embodiment of the vehicle's communication system 120 that can operate in portions of the communication system 100. The communication system 120 can include an amplifier 210 and antenna 215 for providing the wireless signal received from the transmitter 170 to the Physical (PHY) layer 140. A Media Access Control (MAC) unit 220 can be used to extract the data from the received packets and feed the result to a processor 240 having a memory storage device 245 for storing speed limit information including the applicable speed limit based on a particular area, such as a longitude and latitude range. The GPS receiver 130 can obtain the satellite signal from the GPS satellite 155 and feed the position information to the processor 240 for storing the position of the vehicle 110, such as longitude and latitude points.

The processor 240 can compare the position information with the speed limit information, and can actuate a driver alert device 250 if warranted, such as a visual and/or audio warning of excessive speed. The processor 240 can also be connected to a speed controller 275, such as a governor or throttle control, which can adjust a speed of the vehicle 110.

FIG. 3 depicts an exemplary embodiment of the transmitter 170 of the broadcast system 160 that can operate in portions of the communication system 100. The transmitter 170 can include a processor 310 having a memory storage device 315 for storing the speed limit information therein, which can be inputted into the transmitter via an interface 320, such as a user interface or server interface. As described above, the speed limit information can include the speed limit, and the longitude and latitude range for which the speed limit is applicable, and can also include a time period for broadcasting the speed limit, and a network identifier such as a Service Set Identifier (SSID). In one embodiment, the processor 310 can provide public safety information, as described above, for broadcast to the vehicle 110.

The processor 310 can provide the speed limit and latitude/longitude information to a Media Access Control (MAC) unit 330 to form the packets and subsequently submit to the PHY layer, which in turn can feed the packetized information to the transmitter circuit 340, amplifier 350 and antenna 360 for wireless broadcasting.

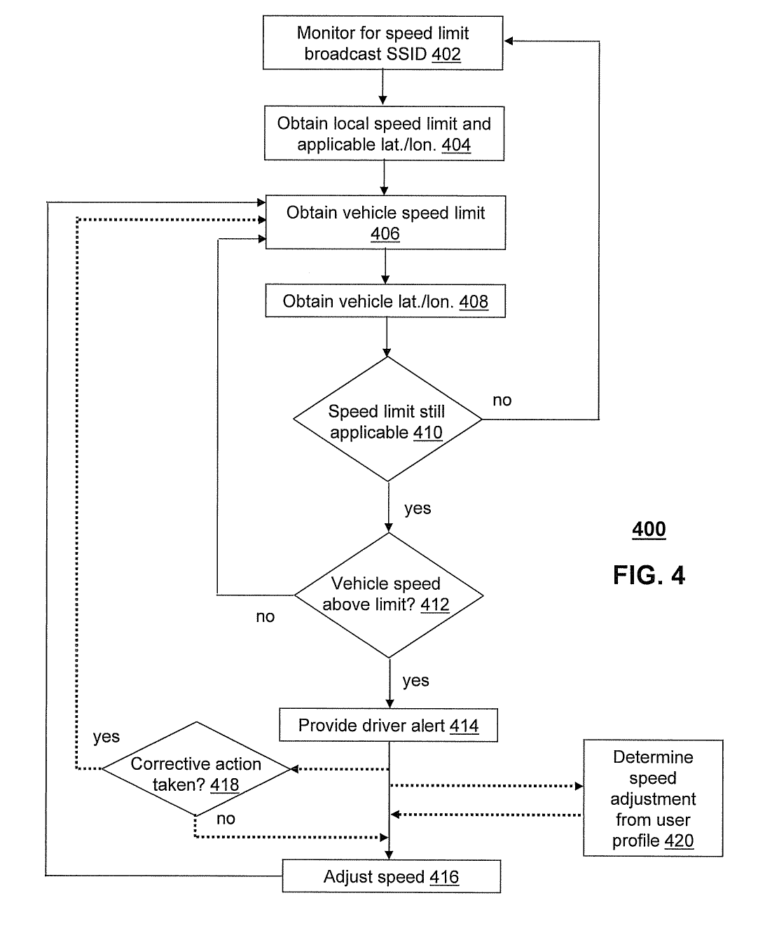

FIG. 4 depicts an exemplary method 400 operating in portions of the communication system 100. Method 400 has variants as depicted by the dashed lines. It would be apparent to an artisan with ordinary skill in the art that other embodiments not depicted in FIG. 4 are possible without departing from the scope of the claims described below.

Method 400 begins with step 402 in which the receiver 140 of the vehicle 110 can monitor for a speed limit broadcast SSID. In step 404, once such a signal is received, the speed limit information can be determined by the vehicle's processor 240 from the broadcast signal. As described above, the speed limit information can include a speed limit, as well as an area of applicability based upon a range of longitude and latitude. The vehicle speed limit can then be obtained by the processor 240 from the speed sensor 230 as in step 406. The vehicle position, such as based on longitude and latitude points, can be determined by the processor 240 based upon the information received and/or processed by the GPS receiver 130.

In step 410, the processor 240 can determine if the received speed limit information is still applicable for the particular location of the vehicle 110. If the speed limit information is not applicable, then method 400 can return to step 402 to monitor for other speed limit broadcast SSIDs. If on the other hand, the speed limit information is applicable then in step 412 the processor 240 can determine if the vehicle speed is above the broadcast speed limit. If the vehicle speed is not above the broadcast speed limit then method 400 can return to step 406 to monitor the vehicle speed. If on the other hand, the vehicle speed is above the broadcast speed limit then in step 414 an alert or other notification can be provided to the driver by processor 240 using driver alert 250.

In step 416, the processor 240 can adjust the speed of the vehicle or otherwise exert speed-related control over the vehicle (e.g., cap the speed of the vehicle) and then can continue monitoring for broadcast speed limit information or obtain the vehicle speed limit information. In one embodiment, the processor 240 can determine if a driver has taken corrective action (e.g., has eased-off on the gas pedal) as in step 418. In another embodiment, the corrective action can include an acknowledgement of the excessive speed (e.g., an override of the speed adjustment).

If the driver has taken corrective action then method 400 can bypass the adjustment of speed and continue monitoring for broadcast speed limit information or obtain the vehicle speed limit information. If on the other hand, the driver has not taken corrective action then method 400 can proceed to the adjustment of speed in step 416. In one embodiment, the processor 240 can provide a time limit for the corrective action. In another embodiment, the processor 240 can notify the user of the time limit for the corrective action, including a countdown to take the action.

In one embodiment, the driver notification of step 414 and/or the speed adjustment of step 416 can be based on a user profile associated with the driver of the vehicle, as in step 420. For example, upon starting the vehicle, the driver can input a password or other driver identification associated with a user profile for the driver stored by the vehicle communication system 120. The processor 240 can then utilize information in the user profile to implement one or both of the driver notification and the speed adjustment. For instance, a primary driver of the vehicle may designate only driver alerts to be provided and only for a certain speed over the limit.

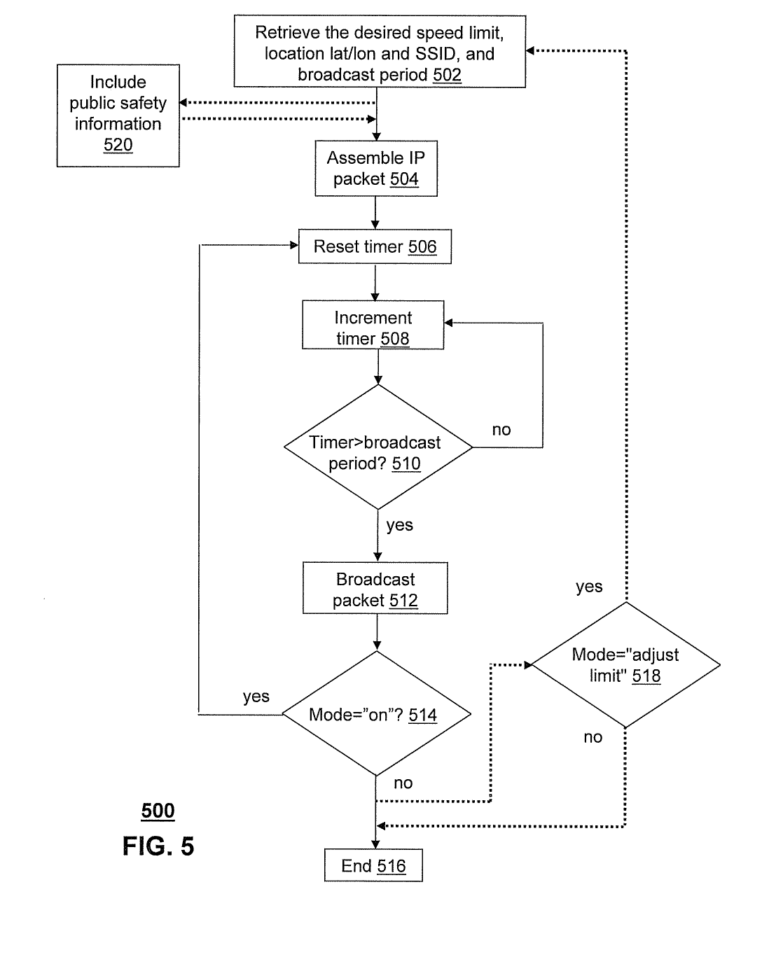

FIG. 5 depicts an exemplary method 500 operating in portions of the communication system 100. Method 500 has variants as depicted by the dashed lines. It would be apparent to an artisan with ordinary skill in the art that other embodiments not depicted in FIG. 5 are possible without departing from the scope of the claims described below.

Method 500 begins with step 502 in which the processor 310 of the transmitter 170 can obtain the speed limit information that is to be broadcast, such as the speed limit, the longitude and latitude range, the SSID for the broadcast signal, and a broadcast time period. In step 504, the processor 310 can assemble an IP packet for transmission. A timer can be reset at step 506 and then incremented in step 508. In step 510, the processor 310 can determine if the timer exceeds the broadcast time period. If the timer does not exceed the broadcast time period then method 500 can return to step 508 to increment the timer. If on the other hand, the timer does exceed the broadcast time period then in step 512 the IP packet comprising the speed limit information can be broadcast.

In step 514, the processor 310 can determine if the transmitter 170 is in the “on” mode. If the transmitter 170 is in the “on” mode then method 500 can return to step 506 to reset the timer for broadcasting of the IP packet. If on the other hand, the transmitter 170 is not in the “on” mode then method 500 can end the broadcast process. In one embodiment, the processor 310 can determine if the transmitter 170 is in an “adjust limit” mode, as in step 518. If the transmitter 170 is in the “adjust limit” mode then method 500 can return to step 502 to obtain the speed limit information to be broadcast, which can include an adjusted desired speed limit. If on the other hand, the transmitter 170 is not in the “adjust limit” mode then method 500 can end the broadcast process. In another embodiment as shown in step 520, the IP packet that is broadcast by the transmitter 170 can include public safety information as described above.

Upon reviewing the aforementioned embodiments, it would be evident to an artisan with ordinary skill in the art that said embodiments can be modified, reduced, or enhanced without departing from the scope and spirit of the claims described below. For example, a driver can adjust the system as he or she desires. The adjustments can be pursuant to the user profile associated with the driver or can be done through manual input, including adjustments to the type of alert being provided (e.g., volume, brightness, and so forth) and/or the type of public safety information to be provided (e.g., only weather related information). The user profiles can also be provided with a hierarchy. For example, a primary driver can designate a notification type, speed adjustment, and so forth for secondary drivers despite user profiles for the secondary drivers or other selections by those secondary drivers that are to the contrary. The present disclosure also contemplates the excessive speed limit information and/or notifications of this information being transmitted to third parties and/or stored for review by third parties. For example, a parent can review excessive speed limit information stored by the processor 240 as it relates to his or her child's driving during the prior evening.

In another embodiment, the communication system 120 and/or the broadcast system 160 can accommodate different modes of communication. For example, the processor 120 in the vehicle 110 can be a multimode system that can detect a mode of communication being utilized by a transmitter 170 and process those signals according to that particular mode of communication. As another example, the transmitter 170 can broadcast the speed limit information using a plurality of modes of communication, such as GSM, GPRS, EDGE, CDMA-1X, UMTS, WiMAX, software defined radio (SDR), WiFi, and so forth, so that vehicles 110 having different communication capabilities can each receive and process the signals. In yet another embodiment, the speed and latitude/longitude information can be retrieved from a storage device connected to the receiver 120 via, for example, a USB (Universal Serial Bus) connection.

These are but a few examples of modifications that can be applied to the present disclosure without departing from the scope of the claims. Accordingly, the reader is directed to the claims section for a fuller understanding of the breadth and scope of the present disclosure.

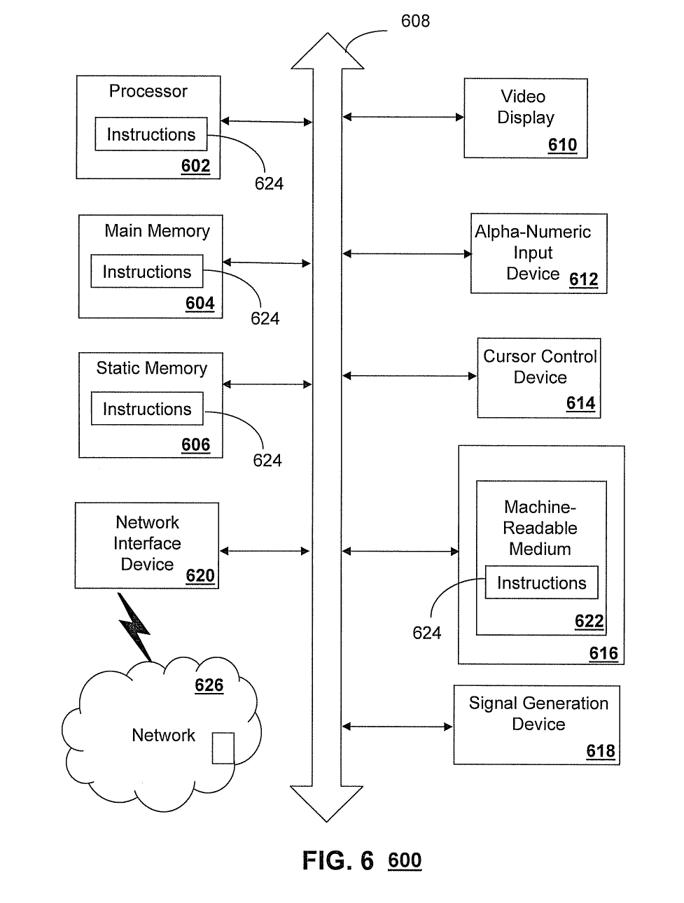

FIG. 6 depicts an exemplary diagrammatic representation of a machine in the form of a computer system 600 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 600 may include a processor 602 (e.g., a central processing unit (CPU), a graphics processing unit (GPU, or both), a main memory 604 and a static memory 606, which communicate with each other via a bus 608. The computer system 600 may further include a video display unit 610 (e.g., a liquid crystal display (LCD), a flat panel, a solid state display, or a cathode ray tube (CRT)). The computer system 600 may include an input device 612 (e.g., a keyboard), a cursor control device 614 (e.g., a mouse), a mass storage medium 616, a signal generation device 618 (e.g., a speaker or remote control) and a network interface device 620.

The mass storage medium 616 may include a computer-readable storage medium 622 on which is stored one or more sets of instructions (e.g., software 624) embodying any one or more of the methodologies or functions described herein, including those methods illustrated above. The computer-readable storage medium 622 can be an electromechanical medium such as a common disk drive, or a mass storage medium with no moving parts such as Flash or like non-volatile memories. The instructions 624 may also reside, completely or at least partially, within the main memory 604, the static memory 606, and/or within the processor 602 during execution thereof by the computer system 600. The main memory 604 and the processor 602 also may constitute computer-readable storage media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 624, or that which receives and executes instructions 624 from a propagated signal so that a device connected to a network environment 626 can send or receive voice, video or data, and to communicate over the network 626 using the instructions 624. The instructions 624 may further be transmitted or received over a network 626 via the network interface device 620.

While the computer-readable storage medium 622 is shown in an example embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure.

The term “computer-readable storage medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a computer-readable storage medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer-readable storage medium, comprising computer instructions for:
receiving speed limit information from a remote wireless transmitter, the speed limit information comprising a speed limit and an applicable speed area;
receiving location information associated with a vehicle;
determining a location of the vehicle based at least in part on the location information;
determining a speed of the vehicle;
determining an excessive speed when the speed of the vehicle exceeds the speed limit and when the location of the vehicle is within the applicable speed area;
providing a driver notification of the excessive speed; and
adjusting the speed of the vehicle when corrective action has not been taken by a driver within a pre-determined time period.

2. The storage medium of claim 1, wherein the corrective action is at least one of reducing the speed of the vehicle and acknowledging the driver notification.

3. The storage medium of claim 1, comprising computer instructions for providing the driver notification of the excessive speed based on a user profile associated with the driver.

4. The storage medium of claim 1, comprising computer instructions for receiving the speed limit information from the remote wireless transmitter by way of a plurality of modes of communication.

5. The storage medium of claim 1, comprising computer instructions for determining the location of the vehicle using satellite signals received from a global positioning system.

6. The storage medium of claim 1, comprising computer instructions for receiving public safety information from the remote wireless transmitter and presenting at least a portion of the public safety information to the driver by at least one of an audio message and a visual message.

7. A communication device, comprising a controller to:
receive speed limit information from a remote wireless transmitter, the speed limit information comprising a speed limit and an applicable speed area;
receive location information associated with a vehicle;
determine a location of the vehicle based at least in part on the location information;
determine a speed of the vehicle;
determine an excessive speed when the speed of the vehicle exceeds the speed limit and when the location of the vehicle is within the applicable speed area; and
provide a driver notification of the excessive speed according to a user profile associated with a driver of the vehicle.

8. The communication device of claim 7, wherein the controller is adapted to adjust the speed of the vehicle when corrective action has not been taken by the driver in response to the driver notification within a pre-determined time period.

9. The communication device of claim 8, wherein the corrective action is at least one of reducing the speed of the vehicle and acknowledging the driver notification.

10. The communication device of claim 7, wherein the controller is a multimode communication device and is adapted to receive the speed limit information from the remote wireless transmitter by way of a plurality of modes of communication.

11. The communication device of claim 10, wherein the controller is adapted to detect a mode of communication being used by the remote wireless transmitter.

12. The communication device of claim 7, wherein the controller is adapted to determine the location of the vehicle using satellite signals received from a global positioning system.

13. The communication device of claim 7, wherein the controller is adapted to receive public safety information from the remote wireless transmitter and present at least a portion of the public safety information to the driver.

14. The communication device of claim 13, wherein the at least a portion of the public safety information presented to the driver is based on the user profile associated with the driver.

15. A communication device, comprising a controller to:
wirelessly broadcast speed limit information and public safety information, wherein the speed limit information comprises a speed limit and an applicable speed area, wherein a vehicle determines an excessive speed based on the speed limit information and location information received from a global positioning system, and wherein the vehicle presents a driver notification comprising the excessive speed and at least a portion of the public safety information.

16. The communication device of claim 15, wherein the controller is a multimode communication device and is adapted to broadcast the speed limit information and the public safety information by way of a plurality of modes of communication.

17. The communication device of claim 15, wherein the controller is adapted to receive at least one of the speed limit information and the public safety information from a remote source.

18. The communication device of claim 15, wherein the controller is adapted to adjust at least one of the speed limit and the applicable speed area of the speed limit information based on an operator input at an operator interface of the communication device.

19. A communication device, comprising a controller to:
receive speed limit information from a remote wireless transmitter, the speed limit information comprising a speed limit and an applicable speed area;
receive location information associated with a vehicle;
determine a location of the vehicle based at least in part on the location information;
determine a speed of the vehicle;
determine an excessive speed when the speed of the vehicle exceeds the speed limit and when the location of the vehicle is within the applicable speed area; and
adjust the speed of the vehicle based at least in part on the excessive speed.

20. The communication device of claim 19, wherein the controller is adapted to provide a driver notification of the excessive speed according to a user profile associated with a driver of the vehicle.

21. The communication device of claim 19, wherein the controller adapted to detect a mode of communication being used by the remote wireless transmitter and receive the speed limit information using the mode of communication.

22. The communication device of claim 19, wherein the controller is adapted to receive public safety information from the remote wireless transmitter and present at least a portion of the public safety information to a driver.

23. A method, comprising:
transmitting speed limit information from a remote wireless transmitter to a first receiver of a vehicle, the speed limit information comprising a speed limit and an applicable speed area;
transmitting location information from a global positioning system to a second receiver of the vehicle, the location information being associated with the vehicle;
determining a location of the vehicle based at least in part on the location information;
determining a speed of the vehicle;
determining an excessive speed when the speed of the vehicle exceeds the speed limit and when the location of the vehicle is within the applicable speed area;
storing occurrences of the excessive speed over a time period; and
presenting the occurrences of the excessive speed in response to a user's request.

24. The method of claim 23, comprising providing a driver notification of the excessive speed.

25. The method of claim 24, comprising adjusting the speed of the vehicle when corrective action has not been taken by a driver within a pre-determined time period.
